(19) United States
(12) Patent Application Publication
(10) Pub. No.: US 2024/0110258 A1
(43) Pub. Date: Apr. 4, 2024

(54) AUTOCLAVE AND PRESSURE OXIDATION METHOD

(71) Applicant: Metso Outotec Finland Oy, Tampere (FI)

(72) Inventors: Marko Latva-Kokko, Pori (FI); Antti Saarikoski, Espoo (FI); Pekka Immonen, Vantaa (FI); Teemu Ritasalo, Espoo (FI)

(73) Assignee: Metso Outotec Finland Oy, Tampere (FI)

(21) Appl. No.: 17/768,750

(22) PCT Filed: Oct. 15, 2019
(86) PCT No.: PCT/FI2019/050736

§ 371 Date: Apr. 13, 2022

(51) Int. Cl. C22B 3/02; B01J 3/04; C22B 3/00; C22B 3/04; C22B 15/00; C22B 19/20

(52) U.S. Cl. CPC C22B 3/02; B01J 3/04; C22B 3/04; C22B 15/0065; C22B 19/20; C22B 23/0407

(57) ABSTRACT

An autoclave for pressure oxidation of a slurried material including at least one sulfide material, and a method. The autoclave includes a pressure vessel for receiving the slurried material. The pressure vessel includes compartments being arranged horizontally one after the another and separated by dividers. Each divider is provided with an upper edge or at least one opening that defines level of the slurried material in the compartment. An inlet is arranged for feeding oxygen-containing gas into the pressure vessel. An agitator arrangement is arranged for agitating the slurried material in at least one of the compartments, the agitator arrangement including at least an upper impeller and a lower impeller, the impellers arranged along a vertically aligned shaft. The upper impeller is arranged at a height above the mid-level of one of the compartments, and the upper impeller is an upward pumping axial or mixed flow impeller.

### BACKGROUND

The invention relates to an autoclave for pressure oxidation of a slurried material comprising at least one sulfide material.

The invention further relates to a method for pressure oxidation of a slurried material comprising at least one sulfide material.

Pressure oxidation (POX) process is a common hydrometallurgical process that is carried out at elevated temperature and pressure to leach various sulfidic minerals containing iron, nickel, cobalt, zinc or copper. Typical pressurized leaching configuration involve a multi-compartment horizontal tank, i.e. an autoclave, comprising one or more agitator(s).

Leaching process requires significant amount of oxygen that is typically fed as pure oxygen gas or oxygen enriched air to the bottom of the tank, below the agitator. In an alternative way, gas may be fed through an agitator.

However, there are still problems regarding effectiveness of the autoclaves and leaching processes.

### BRIEF DESCRIPTION

Viewed from a first aspect, there can be provided an autoclave for pressure oxidation of a slurried material comprising at least one sulfide material, the autoclave comprising a pressure vessel for receiving said slurried material, the pressure vessel comprising compartments being arranged horizontally one after the another and separated by divider(s), the divider being provided with an upper edge or at least one opening that defines level of the slurried material in the compartment, an inlet for feeding oxygen-containing gas into the pressure vessel, an agitator arrangement for agitating said slurried material and arranged in at least one of the compartments, the agitator arrangement comprising at least an upper impeller and a lower impeller, the impellers arranged in a vertically aligned shaft, the upper impeller arranged at a height above the mid-level of said one of the compartments, wherein the upper impeller is an upward pumping axial or mixed flow impeller.

Thereby an autoclave utilizing of surface oxidation and being highly effective may be achieved. The utilization of surface oxidation in an autoclave gives several benefits over typical autoclave design.

Viewed from a further aspect, there can be provided a method for pressure oxidation of a slurried material comprising at least one sulfide material, the method comprising
feeding the slurried material in a pressure vessel,
the pressure vessel comprising compartments being arranged horizontally one after the another and separated by divider(s),
feeding an oxygen-containing gas into the pressure vessel,
agitating the slurried material by an agitator arrangement, said arrangement comprising an upper impeller and a lower impeller, the impellers arranged in a vertically aligned shaft,
the upper impeller arranged at a height above the mid-level of the compartment, wherein the method further comprises
pumping the slurried material upward by the upper impeller.

Thereby a more effective method may be achieved.

The autoclave and the method are characterised by what is stated in the independent claims. Some other embodiments are characterised by what is stated in the other claims. Inventive embodiments are also disclosed in the specification and drawings of this patent application. The inventive content of the patent application may also be defined in other ways than defined in the following claims.

In one embodiment of the autoclave and the method, a distance of the upper impeller from the level of the slurried material in at least one of said compartments is equal to or less than diameter of said upper impeller. An advantage is that the upper impeller may generate flow to rapidly change the slurry at the surface of the slurry.

In one embodiment of the autoclave and the method, a distance of the upper impeller from the level of the slurried material in at least one of said compartments is equal to or less than 0.5×diameter of said upper impeller. An advantage is that the upper impeller may generate more effective flow to rapidly change the slurry at the surface of the slurry.

In one embodiment of the autoclave and the method, the distance of the upper impeller from the level of the slurried material is equal to or less than 0.3×diameter of the upper impeller. An advantage is that the upper impeller may generate even more effective flow to rapidly change the slurry at the surface of the slurry.

In one embodiment of the autoclave and the method, the distance of the upper impeller from the level of the slurried material is equal to or more than 0.1×diameter of the upper impeller. An advantage is that splashing of the slurried material may be avoided.

In one embodiment of the autoclave and the method, the upper impeller is an upward pumping axial flow impeller. An advantage is that the energy of the upper impeller is focused to the surface of the slurry, and thus an effective flow to rapidly change the slurry at the surface of the slurry may be created.

In one embodiment, the upper impeller comprises at least three blades. An advantage is that the impeller may generate an effective flow of slurry.

In one embodiment, the blades of the upper impeller have an angle 30°-40° with horizontal plane. An advantage is that flow generated by the upper impeller is directed upwards towards the surface of the slurry.

In one embodiment of the autoclave and the method, the lower impeller is a downward pumping axial or mixed flow impeller. An advantage is that good solids suspension and fast blending of the dissolved oxygen may be realized.

In one embodiment, the lower impeller is a downward pumping axial flow impeller. An advantage is that solids suspension and fast blending of the dissolved oxygen may be further contributed.

In one embodiment, the lower impeller is arranged at a height below the mid-level of said at least one of the compartments. An advantage is that an effective circulation of the whole volume of slurry in the compartment may be achieved.

In one embodiment, the upper and the lower impeller are attached to the shaft and arranged to rotate with a same rotation speed. An advantage is that a simple structure of the agitator arrangement may be achieved.

In one embodiment, the diameter H of the upper impeller is 0.9-1.4×I, wherein I is the diameter of the lower impeller. An advantage is that a flow pattern advantageous in some leaching processes may be achieved.

In one embodiment, the upper impeller has a greater diameter than the lower impeller attached to a same shaft. An advantage is that an efficiency of oxygen transfer may be improved.

In one embodiment of the autoclave and the method, the gas inlet is arranged to feed oxygen-containing gas in or above the horizontal level of the upper impeller. An advantage is that scaling may be reduced due to higher flow velocities at compartment walls. Still further, the required mixing power may be lowered (even to approximately ⅕ of a typical design).

In one embodiment of the autoclave and the method, the gas inlet is arranged to feed oxygen-containing gas into the gas phase of the pressure vessel, above the level of the slurried material. An advantage is that presence of gas bubbles in proximity of the impellers is minimized and thus overall mixing and especially solids suspension performance may be improved. Additionally, impeller wear rate may be decreased due to minimizing cavitation taking place on surfaces of the impeller. Further, there will not be any flooding issues or gas inlet pipe blockages. Still further, retention time of the solid particles in a continuous operation may be increased due to minimization of gas hold-up in the slurry, and gas inlet system is cheaper and easier to control.

In one embodiment of the autoclave and the method, the inlet is arranged to feed oxygen-containing gas below the level of the slurried material, in or above the horizontal level of the upper impeller. An advantage is that presence of gas bubbles in proximity of the impellers may be limited and thus overall mixing and especially solids suspension performance may be improved. Additionally, impeller wear rate may be decreased due to minimizing cavitation taking place on surfaces of the impeller. Still further, retention time of the solid particles in a continuous operation may be increased due to limited gas hold-up in the slurry.

In one embodiment, the gas inlet is arranged to feed oxygen-containing gas into first of said compartments. An advantage is that portion of slurry just fed in the autoclave may react with a fresh gas.

In one embodiment, the pressure vessel is a horizontally arranged cylinder. An advantage is that pressure oxidation processes are easy to carry out in such a vessel, and that plurality of compartments may be construed therein.

In one embodiment, the pressure vessel comprises at least three compartments. An advantage is that a complete pressure oxidation of slurry may be achieved due to improved distribution of residence time.

In one embodiment, the autoclave comprises the agitator arrangement in every compartments. An advantage is that an effective oxidation in every compartment may be achieved.

In one embodiment, the autoclave comprises at least one compartment devoid of the agitator arrangement. An advantage is that the capital expenditure of the autoclave may be lowered.

In one embodiment, the autoclave comprises a second type of agitator arrangement in the last of said compartments. An advantage is that the function of the autoclave may be optimized.

In one embodiment, the autoclave is used for leaching sulfidic material containing iron.

In one embodiment, the autoclave is used for leaching sulfidic material containing nickel.

In one embodiment, the autoclave is used for leaching sulfidic material containing cobalt.

In one embodiment, the autoclave is used for leaching sulfidic material containing zinc.

In one embodiment, the autoclave is used for leaching sulfidic material containing copper.

### BRIEF DESCRIPTION OF FIGURES

Some embodiments illustrating the present disclosure are described in more detail in the attached drawings, in which

FIG. 1 is a schematic side view of an autoclave and method in partial cross-section,

FIGS. 2a, 2b are schematic views of an upper impeller,

FIGS. 3a, 3b are schematic views of a lower impeller,

FIG. 4 is a schematic side view of another autoclave and method, and

FIG. 5 illustrates a method for pressure oxidation of a slurried material.

In the figures, some embodiments are shown simplified for the sake of clarity. Similar parts are marked with the same reference numbers in the figures.

### DETAILED DESCRIPTION

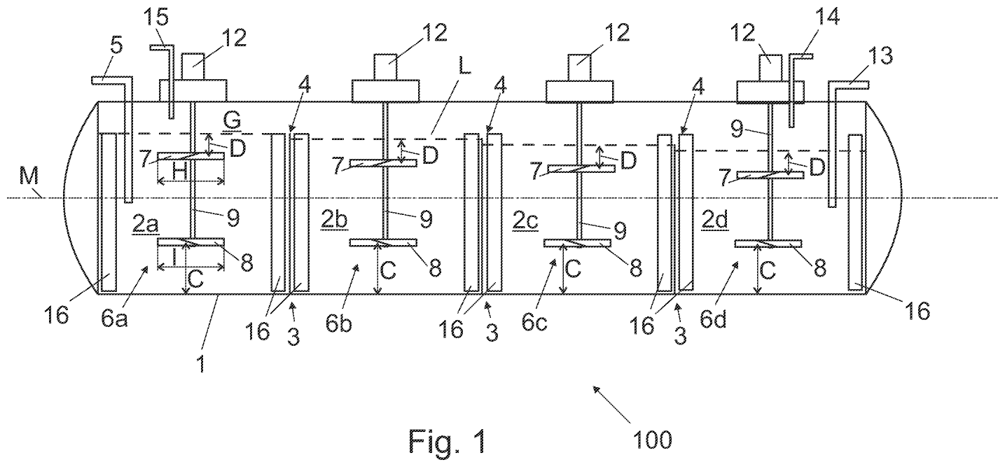

FIG. 1 is a schematic side view of an autoclave for pressure oxidation of a slurried material comprising at least one sulfide material, and method in partial cross-section.

The autoclave 100 comprises a pressure vessel 1 that is a horizontally arranged cylinder. The diameter of the pressure vessel 1 is typically in range 1.5 m-7 m. Slurried material to be oxidized is fed in the pressure vessel 1 through an inlet 5, whereas oxidized slurry is removed from the pressure vessel through a slurry discharge channel 13.

It is to be noted that the pressure vessel 1 may comprise a heating arrangement, or a cooling element, or both, for controlling temperature of slurried material in the pressure vessel 1.

The pressure vessel 1 comprises at least two compartments (four in shown embodiment) 2a-2d being arranged horizontally one after the another and separated by typically vertically arranged dividers or walls 3. The divider 3 has an upper edge 4, or at least one opening, that defines level L of the slurried material in the compartment 2a-2d. Typically, the level L in the next compartment is lower than in the previous compartment, as shown in FIG. 1.

In an embodiment, one or more baffles 16 are arranged in at least one of the compartments.

The autoclave 100 comprises a gas inlet 15 for feeding oxygen-containing gas into the pressure vessel 1. Said gas may be pure oxygen gas, oxygen enriched air or another gas mixture comprising oxygen.

Agitator arrangements 6a-6d are arranged for agitating said slurried material. In an embodiment (for instance as shown in FIG. 1), there is an agitator arrangement in every compartment 2a-2d of the autoclave 1; however, this is not always necessary.

In an embodiment, the agitator arrangement 6a-6d comprises two impellers; an upper impeller 7 and a lower impeller 8, the impellers arranged in a vertically aligned shaft 9. In an embodiment, the upper and the lower impeller 7, 8 are attached to the shaft 9 and arranged to rotate with a same rotation speed. The shaft and the impellers are rotated by a motor unit 12, that may comprise e.g. an electric motor. In an embodiment, the motor unit 12 comprises also a transmission for providing a transmission ratio between the motor and the shaft.

In an embodiment, the upper impeller 7 is arranged at a height above the mid-level M of the compartment 2a-2d. In one embodiment, a distance of the upper impeller 7 from the level of the slurried material L is equal to or less than diameter H of said upper impeller.

In another embodiment, a distance D of the upper impeller 7 from the level L of the slurried material in the corresponding compartment 2a-2d is equal to or less than 0.5×diameter H of said upper impeller 7. The distance D is measured from the middle (in height) of blades of the upper impeller.

In still another embodiment, the distance D is equal to or less than 0.3×diameter H of the upper impeller 7. In an embodiment, the distance D is equal to or more than 0.1×diameter H of the upper impeller.

Type of the upper impeller 7 is an upward pumping axial or mixed flow impeller. By an upward pumping mixed flow impeller is herein meant an impeller generating flow to several directions and at least some flow upwards. An upward pumping axial impeller means that substantially all the flow is generated upwards.

The lower impeller 8 is arranged at a height below the mid-level M of the compartment 2a-2d, and at a clearance C above the bottom of the compartment. The clearance C is measured from the middle (in height) of blades of the impeller.

Type of the lower impeller 8 may be selected freely. In an embodiment, the lower impeller 8 is a downward pumping axial or mixed flow impeller. The downward pumping axial flow impeller means that substantially all the flow is generated towards the bottom. The downward pumping mixed flow impeller means impeller that generates flow to several directions, as long as some of the flow is directed towards the bottom of the compartment.

In an embodiment, the upper and the lower impeller 7, 8 that are attached to a same shaft 9 have an equal diameter. However, in another embodiments, the impellers have different diameters. In an embodiment, the upper impeller 7 has a greater diameter H than the diameter I of the lower impeller 8 attached to a same shaft 9, for instance the diameter of the upper impeller 7 may be 20%-30% greater than the diameter of the lower impeller 8. In still another embodiment, the lower impeller has greater diameter than the upper impeller.

According to an aspect, the dimensions and design of the upper impeller 7 are selected such that the upper impeller 7 is able to provide circulation of slurried material to the boundary of gas phase G in an extent necessary for adequate oxidation of said slurried material. The dimensions and design of the lower impeller 7 are selected such that it provides a sufficient flow for circulating slurried material from the bottom of the compartment up, but, on the other hand, has preferably as low power consumption as possible.

In an embodiment, at least one of the agitator arrangements has further impeller(s) arranged between the upper and the lower impeller 7, 8.

In an embodiment, there are variations in positions of the impellers so that at least one of the upper impellers 7 and/or lower impellers 8 is differently positioned in axial direction of the shaft 9 than the others. For instance, in the embodiment shown in FIG. 1, the upper impeller 7 in a previous compartment is arranged higher than the upper impeller 7 in the next compartment, whereas all the lower impellers 8 are arranged on the same horizontal level. Thus, the distance between the upper impeller 7 and the lower impeller 8 is not constant in the agitator arrangements 6a-6d but is decreasing from the maximum value in the first compartment 2a to the minimum value in the last compartment 2d.

In another embodiment, all the upper impellers 7 are arranged on the same horizontal level.

In an embodiment, the gas inlet 15 is arranged to feed oxygen-containing gas into the gas phase G of the pressure vessel 1, that is above the level L of the slurried material. In the embodiment shown in FIG. 1, the gas inlet 15 extends from the wall of the pressure vessel 1 in the interior thereof. In another embodiment, the inlet 15 may be just an opening in the wall of the pressure vessel 1.

In another embodiment, the gas inlet 15 is arranged to feed oxygen-containing gas below the level L of the slurried material, in or above the horizontal level of the upper impeller 7.

In the embodiment shown in FIG. 1, the gas inlet 15 is arranged to feed oxygen-containing gas into first of said compartments 2a. However, it is also possible to arrange the gas inlet 15 in second 2b or further compartment. In an embodiment, there are multiple gas inlets 15 arranged in the autoclave 100, feeding oxygen-containing gas in one or several of the compartments. In a still further embodiment, the gas inlet 15 is arranged in the last compartment whereas the gas discharge 14 is arranged in the first compartment 2a, thus creating a countercurrent flow of gas in relation to flowing direction of the slurry.

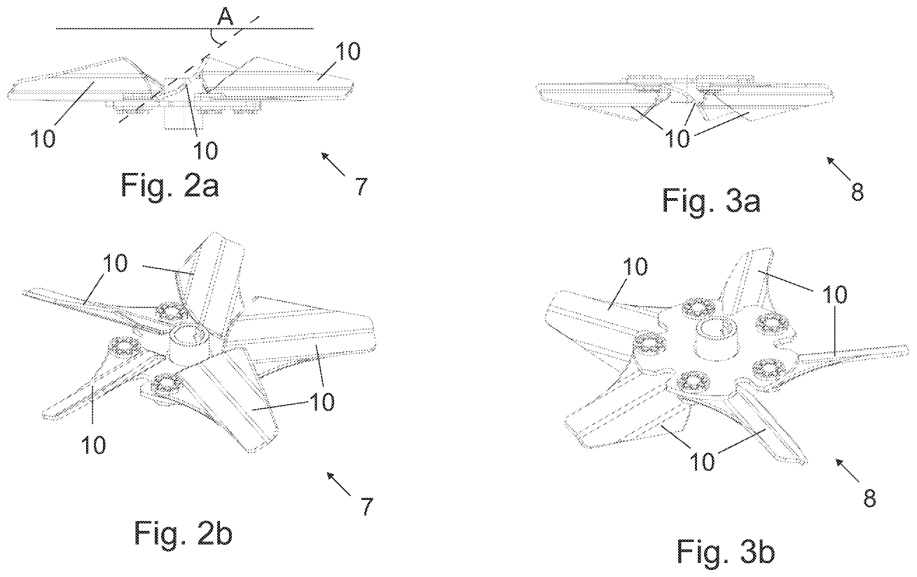

FIGS. 2a, 2b are schematic views of an upper impeller. The upper impeller 7 is an upward pumping axial flow impeller that comprises five blades 10. According to an idea, the upper impeller 7 comprises at least three blades 10.

In an embodiment, the blades 10 of the upper impeller 7 have an angle 30°-40° with horizontal plane. In the shown embodiment, said angle A is about 36°. The profile or cross-section of the blade 10 may be curved (e.g. as in FIG. 2a), but not necessary; said profile may also be straight or varying comprising curved and straight sections.

FIGS. 3a, 3b are schematic views of a lower impeller. Shown impeller 8 is a downward pumping axial flow impeller having five blades 10. It is to be noted, however, that the type of the lower impeller 8 may be selected quite freely.

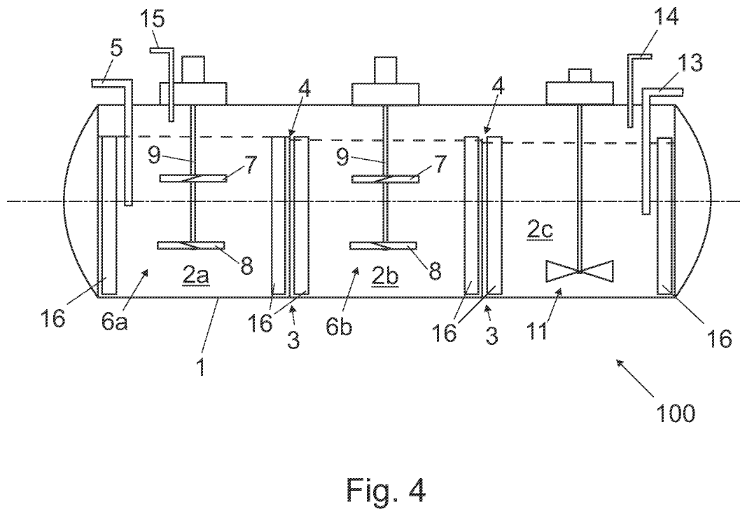

FIG. 4 is a schematic side view of another autoclave and method. This embodiment of autoclave 100 comprises three compartments 2a-2c. The last one of the compartments 2c comprises a second type of agitator arrangement 11, that differs from the agitator arrangements arranged in the first and the second compartments 2a, 2b.

The shown embodiment of second type of the second agitator arrangement 11 comprises a single impeller arranged close to the bottom of the compartment 2c. In another embodiments, the second agitator arrangement 11 may have another structure.

In still another embodiment, at least one the compartments 2a-2d of the pressure vessel, e.g. the last compartment, is without any impellers.

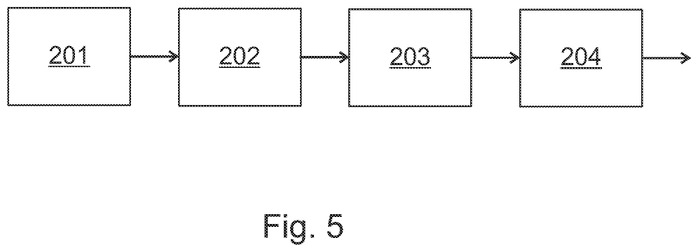

FIG. 5 illustrates a method for pressure oxidation of a slurried material. In this embodiment, the method comprises feeding 201 the slurried material in a pressure vessel 1. In an embodiment, the slurried material is mineral-containing material comprising at least one sulfide mineral. In another embodiment, the slurried material is precipitated metal sulfide material.

The the pressure vessel comprises compartments being arranged horizontally one after the another and separated by vertically arranged divider(s).

The method further comprises feeding 202 oxygen-containing gas into the pressure vessel and agitating 203 the slurried material by an agitator arrangement that comprises an upper impeller and a lower impeller arranged in a vertically aligned shaft. The upper impeller is arranged at a height above the mid-level of the compartment.

The method still further comprises pumping 204 the slurried material upward towards the gas phase of the pressure vessel by said upper impeller.

In an embodiment of the method, said agitating 203 comprises agitating the slurried material in one of the compartments by the upper impeller that is situated at a distance that is equal to or less than 0.5×diameter of said upper impeller from the level of the slurried material.

In an embodiment of the method, said agitating 203 comprises pumping the slurried material downward by the lower impeller.

In an embodiment of the method, said oxygen-containing gas is feeded 202 into the gas phase of the pressure vessel, above the level of the slurried material. In another embodiment of the method, said oxygen-containing gas is feeded 202 below the level of the slurried material, in or above the horizontal level of the upper impeller.

### Example

To evaluate the gas to liquid mass transfer performance in POX conditions, oxidation experiments were made in a six-compartment pilot scale autoclave with solution volume of 65 L. Sodium sulfite was oxidized to sodium sulfate with pure oxygen gas that was fed to the gas phase of the autoclave. The agitator arrangement comprised impellers as shown in FIGS. 2a-3b. During the test, temperature was kept at 210° C. and pressure at 22 bar so that oxygen partial pressure was approximately 5 bar. Impeller diameters were 85 mm and rotation speed 455 rpm.

Oxygen transfer rate through the solution surface was 1.75 Nm3/h without significant amount of bubbles drawn in to the solution. Oxygen transfer was much higher than oxygen demand (˜0.9 Nm3/h) in a POX leaching experiment made earlier with a Cu—Zn sulfide concentrate in similar conditions.

The invention is not limited solely to the embodiments described above, but instead many variations are possible within the scope of the inventive concept defined by the claims below. Within the scope of the inventive concept the attributes of different embodiments and applications can be used in conjunction with or replace the attributes of another embodiment or application.

The drawings and the related description are only intended to illustrate the idea of the invention. The invention may vary in detail within the scope of the inventive idea defined in the following claims.

### REFERENCE SYMBOLS

1 pressure vessel
2a-d compartment
3 divider
4 upper edge of divider
5 slurry inlet
6a-d agitator arrangement
7 upper impeller
8 lower impeller
9 shaft
10 blade
11 second type of agitator arrangement
12 motor unit
13 slurry discharge
14 gas discharge
15 gas inlet
16 baffle
100 autoclave
201-204 method steps
A angle of blade
C clearance
D distance
G gas phase
H diameter of upper impeller
I diameter of lower impeller
L level
M mid-level of compartment

1-35. (canceled)

36. An autoclave for pressure oxidation of a slurried material comprising at least one sulfide material, the autoclave comprising
a pressure vessel for receiving said slurried material,
the pressure vessel comprising compartments being arranged horizontally one after the another and separated by dividers,
the dividers being provided with an upper edge or at least one opening that defines a level of the slurried material in the compartment,
an inlet for feeding oxygen-containing gas into the pressure vessel,
an agitator arrangement for agitating said slurried material and arranged in at least one of the compartments, the agitator arrangement comprising at least an upper impeller and a lower impeller, the impellers arranged in a vertically aligned shaft,
the upper impeller arranged at a height above the mid-level of said one of the compartments, wherein
the type of upper impeller is upward pumping axial flow impeller or upward pumping mixed flow impeller.

37. The autoclave as claimed in claim 36, wherein a distance of the upper impeller from the level of the slurried material in the at least one of said compartments is equal to or less than a diameter of said upper impeller.

38. The autoclave as claimed in claim 37, wherein the distance is equal to or less than half of the diameter of said upper impeller.

39. The autoclave as claimed in claim 38, wherein the distance is equal to or less than 30% of the diameter of the upper impeller.

40. The autoclave as claimed in claim 36, wherein the distance is equal to or more than 10% of the diameter of the upper impeller.

41. The autoclave as claimed in claim 36, wherein the upper impeller is an upward pumping axial flow impeller.

42. The autoclave as claimed in claim 36, wherein the upper impeller comprises at least three blades.

43. The autoclave as claimed in claim 36, wherein the blades of the upper impeller have an angle 30°-40° with horizontal plane.

44. The autoclave as claimed in claim 36, wherein the lower impeller is a downward pumping axial or mixed flow impeller.

45. The autoclave as claimed in claim 44, wherein the lower impeller is a downward pumping axial flow impeller.

46. The autoclave as claimed in claim 36, wherein the lower impeller is arranged at a height below the mid-level of said at least one of the compartments.

47. The autoclave as claimed in claim 36, wherein the upper and the lower impeller are attached to the shaft and arranged to rotate with a same rotation speed.

48. The autoclave as claimed in claim 36, wherein the diameter of the upper impeller is 0.9-1.4×I, wherein I is the diameter of the lower impeller.

49. The autoclave as claimed in claim 36, wherein the upper impeller has a greater diameter than the lower impeller attached to a same shaft.

50. The autoclave as claimed in claim 36, wherein the gas inlet is arranged to feed oxygen-containing gas in or above the horizontal level of the upper impeller.

51. The autoclave as claimed in claim 36, wherein the gas inlet is arranged to feed oxygen-containing gas into the gas phase of the pressure vessel, above the level (L) of the slurried material.

52. The autoclave as claimed in claim 36, wherein the gas inlet is arranged to feed oxygen-containing gas below the level of the slurried material, in or above the horizontal level of the upper impeller.

53. The autoclave as claimed in claim 36, wherein the inlet is arranged to feed oxygen-containing gas into first of said compartments.

54. The autoclave as claimed in claim 36, wherein the pressure vessel is a horizontally arranged cylinder.

55. The autoclave as claimed in claim 36, wherein the pressure vessel comprises at least three compartments.

56. The autoclave as claimed in claim 36, comprising the agitator arrangement in every compartment.

57. The autoclave as claimed in claim 36, comprising at least one compartment devoid of the agitator arrangement.

58. The autoclave as claimed in claim 57, comprising a second type of agitator arrangement in the last of said compartments.

59. The autoclave as claimed in claim 36, wherein the diameter of the pressure vessel is in range of 1.5 m-7 m.

60. A method for pressure oxidation of a slurried material comprising at least one sulfide material, the method comprising
feeding the slurried material in a pressure vessel,
the pressure vessel comprising compartments being arranged horizontally one after the another and separated by dividers,
feeding an oxygen-containing gas into the pressure vessel,
agitating the slurried material by an agitator arrangement, said arrangement comprising an upper impeller and a lower impeller, the impellers arranged in a vertically aligned shaft,
the upper impeller arranged at a height above the mid-level of the compartment, wherein the method further comprises
pumping the slurried material upward by the upper impeller.

61. The method as claimed in claim 60, comprising agitating the slurried material in one of the compartments by the upper impeller being situated at a distance that is equal to or less than diameter of said upper impeller, preferably 0.5×diameter of said upper impeller, from the level of the slurried material.

62. The method as claimed in claim 60, further comprising
feeding said oxygen-containing gas in or above the horizontal level of the upper impeller.

63. The method as claimed in claim 60, further comprising
feeding said oxygen-containing gas into the gas phase of the pressure vessel, above the level of the slurried material.

64. The method as claimed in claim 60, further comprising
feeding said oxygen-containing gas below the level of the slurried material, in or above the horizontal level of the upper impeller.

65. The method as claimed in claim 60, further comprising
pumping the slurried material downward by the lower impeller.

66. Use of the autoclave as claimed in claim 36 for leaching sulfidic material containing iron.

67. Use of the autoclave as claimed in claim 36 for leaching sulfidic material containing nickel.

68. Use of the autoclave as claimed in claim 36 for leaching sulfidic material containing cobalt.

69. Use of the autoclave as claimed in claim 36 for leaching sulfidic material containing zinc.

70. Use of the autoclave as claimed in claim 36 for leaching sulfidic material containing copper.
